(19) United States
(12) Patent Application Publication
(10) Pub. No.: US 2025/0229180 A1
(43) Pub. Date: Jul. 17, 2025

(54) VIRTUAL MAP RENDERING METHOD AND APPARATUS, AND COMPUTER DEVICE AND STORAGE MEDIUM

(71) Applicant: Tencent Technology (Shenzhen) Company Limited, Shenzhen (CN)

(72) Inventors: Yuhao ZHAO, Shenzhen (CN); Junru QIU, Shenzhen (CN); Jinchuan GUO, Shenzhen (CN)

(21) Appl. No.: 19/098,904

(22) Filed: Apr. 2, 2025

Related U.S. Application Data
(63) Continuation of application No. PCT/CN2023/130801, filed on Nov. 9, 2023.

(30) Foreign Application Priority Data
Apr. 19, 2023 (CN) 202310458199.1

(51) Int. Cl. A63F 13/5378

(52) U.S. Cl. CPC A63F 13/5378

(57) ABSTRACT

A virtual map rendering method is performed by a computer device. The method includes: obtaining a first fog bitmap of a virtual map related to a virtual scene, the first fog bitmap comprising color values of a plurality of bitmap regions, the plurality of bitmap regions being in one-to-one correspondence with a plurality of first map regions on the virtual map; determining, in response to a virtual object moving in the virtual scene, an object position of the virtual object on the virtual map based on a scene position of the virtual object in the virtual scene; updating the color values of the bitmap regions in the first fog bitmap based on the object position, to obtain a second fog bitmap; and rendering the virtual map based on the second fog bitmap.

### CROSS-REFERENCE TO RELATED APPLICATIONS

This application is a continuation application of PCT Patent Application No. PCT/CN2023/130801, entitled “VIRTUAL MAP RENDERING METHOD AND APPARATUS, AND COMPUTER DEVICE AND STORAGE MEDIUM” filed on Nov. 9, 2023, which claims priority to Chinese Patent Application 202310458199.1, entitled “VIRTUAL MAP RENDERING METHOD AND APPARATUS, AND COMPUTER DEVICE AND STORAGE MEDIUM” filed on Apr. 19, 2023, both of which are incorporated by reference in their entirety.

### FIELD OF THE TECHNOLOGY

This application relates to the field of computer technologies, and in particular, to a virtual map rendering method and apparatus, and a computer device and a storage medium.

### BACKGROUND OF THE DISCLOSURE

With the development of computer technologies, more types of games begin to use virtual fog. The virtual fog is configured to block a part of a scene in a virtual map in a game, to guide a player to control a virtual object to continuously explore the virtual map and perform a virtual task in the game. How to render virtual maps has become a key focus of research in this field.

### SUMMARY

Embodiments of this application provide a virtual map rendering method and apparatus, and a computer device and a storage medium, which saves storage of a data volume for indicating a situation of virtual fog on a virtual map, and achieves a small data volume processed when the virtual fog on the virtual map is rendered, thereby improving the efficiency of rendering the virtual map. Dynamic changes of the virtual fog with movement of a virtual object can also be presented, to enhance a presentation effect on the virtual fog. Technical solutions are as follow:

In one aspect, a virtual map rendering method is performed by a computer device, the method including:
obtaining a first fog bitmap of a virtual map related to a virtual scene, the first fog bitmap comprising color values of a plurality of bitmap regions, the plurality of bitmap regions being in one-to-one correspondence with a plurality of first map regions on the virtual map;
determining, in response to a virtual object moving in the virtual scene, an object position of the virtual object on the virtual map based on a scene position of the virtual object in the virtual scene;
updating the color values of the bitmap regions in the first fog bitmap based on the object position, to obtain a second fog bitmap; and
rendering the virtual map based on the second fog bitmap.

In another aspect, a computer device is provided, including a processor and a memory, the memory being configured to store at least one computer program, and the at least one computer program, when executed by the processor, causing the computer device to implement the operations performed in the virtual map rendering method in the embodiments of this application.

In another aspect, a non-transitory computer-readable storage medium is provided, having at least one computer program stored therein, the at least one computer program, when executed by a processor of a computer device, causing the computer device to implement the operations performed in the virtual map rendering method in the embodiments of this application.

An embodiment of this application provides a virtual map rendering method. Whether virtual fog exists in each first map region on a virtual map is indicated in a form of a binary value, so that a data volume of a first fog bitmap for indicating whether virtual fog exists in each position on the entire virtual map is small, and resources occupied for storing the first fog bitmap are saved. In addition, a color value of a bitmap region in the first fog bitmap can be dynamically updated according to a position of the virtual object in the virtual scene after the virtual object moves, so that dynamic changes of the virtual fog with the movement of the virtual object can be presented, to enhance a presentation effect on the virtual fog. In addition, since the data volume of the fog bitmap of the virtual map is small, when the virtual map is rendered through the second fog bitmap obtained by update, a data volume being processed is small, thereby improving the efficiency of rendering the virtual map.

### BRIEF DESCRIPTION OF THE DRAWINGS

FIG. 1 is a schematic diagram of an implementation environment of a virtual map rendering method according to an embodiment of this application.

FIG. 2 is a flowchart of a virtual map rendering method according to an embodiment of this application.

FIG. 3 is a flowchart of a virtual map rendering method according to an embodiment of this application.

FIG. 4 is a schematic diagram of division of a virtual map according to an embodiment of this application.

FIG. 5 is a schematic diagram of determining an object position according to an embodiment of this application.

FIG. 6 is a schematic diagram of determining a second map region according to an embodiment of this application.

FIG. 7 is a schematic diagram of a second fog bitmap according to an embodiment of the present disclosure.

FIG. 8 is a schematic diagram of a third fog bitmap according to an embodiment of the present disclosure.

FIG. 9 is a schematic diagram of a fourth fog bitmap according to an embodiment of the present disclosure.

FIG. 10 is a schematic diagram of a virtual map according to an embodiment of this application.

FIG. 11 is a flowchart of rendering a virtual map according to an embodiment of this application.

FIG. 12 is a schematic diagram of a fifth fog bitmap according to an embodiment of the present disclosure.

FIG. 13 is a schematic diagram of another virtual map according to an embodiment of this application.

FIG. 14 is another flowchart of rendering a virtual map according to an embodiment of this application.

FIG. 15 is a block diagram of a virtual map rendering apparatus according to an embodiment of this application.

FIG. 16 is a block diagram of another virtual map rendering apparatus according to an embodiment of this application.

FIG. 17 is a structural block diagram of a terminal according to an embodiment of this application.

### DESCRIPTION OF EMBODIMENTS

To make the objectives, technical solutions, and advantages of this application clearer, the following further describes implementations of this application in detail with reference to the accompanying drawings.

The terms “first”, “second”, and the like used in this application are used for distinguishing identical or similar items that have essentially the same effects and functions. There is no logical or temporal dependency relationship between “first”, “second”, and “n^{th}”, and there is no limitation on quantities and execution orders.

The term “at least one” in this application means one or more, and the term “plurality” in this application means two or more.

In addition, Information (including but not limited to user device information and user personal information), data (including but not limited to data for analysis, stored data, displayed data, and the like), and signals involved in this application are authorized by a user or fully authorized by all parties, and the acquisition, use, and processing of the relevant data need to comply with relevant laws, regulations, and standards of relevant countries and regions. For example, a scene position and object position of a virtual object involved in this application are both obtained with full authorization.

For ease of understanding, terms in this application are explained below.

Virtual scene: It is a virtual environment that an application program displays (or provides) when run on a terminal. The virtual scene may be a simulated environment of a real world, or may be a semi-simulated semi-fictional virtual scene, or may be an entirely fictional virtual scene. The virtual scene may be a two-dimensional virtual scene, a 2.5-dimensional virtual scene, or a three-dimensional virtual scene. For example, the virtual scene may include a sky, a land, an ocean, and the like. The land includes environmental elements such as a desert and a city. A user can control a virtual object to move in the virtual scene.

Virtual object: It is a movable object in a virtual world. The movable object is at least one of a virtual person, a virtual animal, and an animation character. In some embodiments, when the virtual world is a three-dimensional virtual world, the virtual object is a three-dimensional model. Each virtual object has a shape and a volume in the three-dimensional virtual world, and occupies some space in the three-dimensional virtual world. In some embodiments, the virtual object is a three-dimensional character constructed based on a three-dimensional human skeleton technology, and the virtual object implements different external appearances by wearing different skins. In some embodiments, the virtual object may be implemented by using a 2.5-dimensional model or a two-dimensional model. This is not limited in the embodiments of this application.

Horizontal version: It is a game type for controlling a moving route of a game character on a horizontal image, and a moving mode of the game character in a virtual scene is only from left to right or from right to left. In all virtual scene images or most virtual scene images in a horizontal version game, the moving route of the game role is in a horizontal direction. According to content, horizontal version games are games such as horizontal pass, horizontal adventure, horizontal arena, and horizontal policy. According to technologies, horizontal version games are classified into two-dimensional horizontal version games and three-dimensional horizontal version games. A virtual map rendering method provided in an embodiment of this application can be applied to a horizontal version game.

Currently, a commonly used mode is storing a plurality of fog maps in advance. Each fog map includes fog data of each position on a virtual map. The fog data generally uses 0 to 255 to represent a blocking degree of virtual fog at each position. In different game progresses, the virtual map in a game is rendered according to the fog data in the fog maps corresponding to the game progresses.

However, in the foregoing technical solution, since the fog data in each fog map is a value from 0 to 255, the fog data used for rendering the virtual fog is usually large. This not only occupies more memory resources, but also spends long time in processing the data, which affects the efficiency of rendering the virtual map.

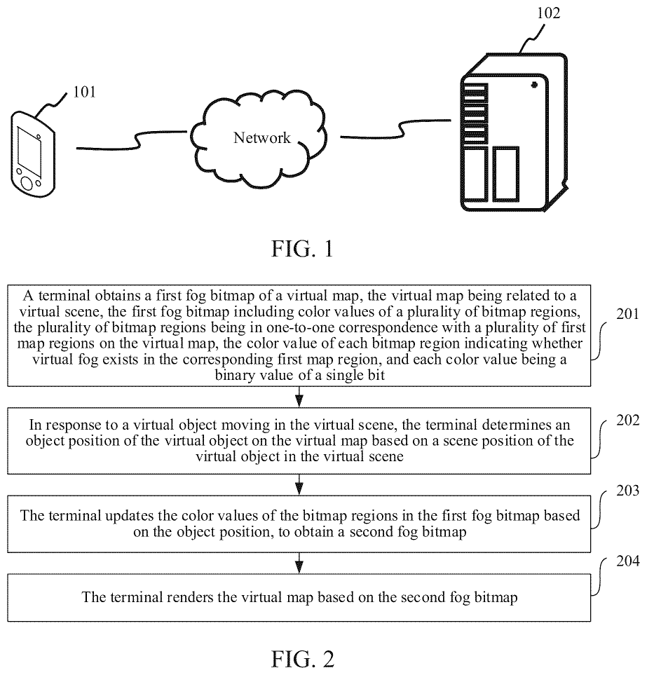

According to this embodiment of this application, the virtual map rendering method can be performed by a computer device. In some embodiments, the computer device is a terminal. The following describes an implementation environment of a virtual map rendering method according to an embodiment of this application by taking the computer device being the terminal as an example. FIG. 1 is a schematic diagram of an implementation environment of a virtual map rendering method according to an embodiment of this application. Referring to FIG. 1, the implementation environment includes a terminal 101 and a server 102. The terminal 101 and the server 102 may be directly or indirectly connected in a wired or wireless communication protocol. This application does not impose a limitation on this.

In some embodiments, the terminal 101 may be, but is not limited to, a smartphone, a tablet, a laptop, a desktop computer, a smart speaker, a smart watch, an intelligent voice interaction device, an intelligent household electrical appliance, and an in-vehicle terminal. An application program supporting a virtual scene is run on the terminal 101. The application program can be any one of a real-time policy game (RTS), a first-person shooting game (FPS), a third-person shooting game, a multiplayer online battle arena game (MOBA), a virtual reality application program, a three-dimensional map program, or a multiplayer online battle survival game. For example, the terminal 101 is a terminal used by a user. The user operates, by using the terminal 101, a virtual object located in a virtual scene to perform an activity. The activity includes, but is not limited to: at least one of adjusting a body posture, crawling, walking, running, riding, jumping, driving, picking up, shooting, attacking, and throwing. Schematically, the virtual object is a virtual person, such as a simulated person character or cartoon character.

Those skilled in the art can appreciate that a quantity of the terminals is more or fewer. For example, there is only one, or dozens of or hundreds of, or more terminals described above. This embodiment of this application does not limit a quantity of the terminal and a device type.

In some embodiments, the server 102 is an independent physical server, or may be a server cluster or a distributed system formed by a plurality of physical servers, or may be a cloud server that provides basic cloud computing services such as cloud services, cloud databases, cloud computing, cloud functions, cloud storage, network services, cloud communication, middleware services, domain name services, security services, content delivery networks (CDNs), big data, and artificial intelligence platforms. The server 102 is configured to provide a backend service for an application program supporting a virtual scene. In some embodiments, the server 102 undertakes primary computation work, and the terminal 101 undertakes secondary computation work. Alternatively, the server 102 undertakes secondary computation work, and the terminal 101 undertakes primary computation work. Alternatively, coordinated computation is performed between the server 102 and the terminal 101.

FIG. 2 is a flowchart of a virtual map rendering method according to an embodiment of this application. Referring to FIG. 2, this embodiment of this application is described by taking the method being performed by a terminal as an example. The virtual map rendering method includes the following steps:

201. The terminal obtains a first fog bitmap of a virtual map, the virtual map being related to a virtual scene, the first fog bitmap including color values of a plurality of bitmap regions, the plurality of bitmap regions being in one-to-one correspondence with a plurality of first map regions on the virtual map, the color value of each bitmap region indicating whether virtual fog exists in the corresponding first map region, and each color value being a binary value of a single bit.

In this embodiment of this application, the virtual scene is related to the virtual map. That the virtual scene is related to the virtual map means that there is a mapping relationship between the virtual scene and the virtual map. The virtual map is divided into the plurality of first map regions. This embodiment of this application does not limit a size and a shape of each first map region. The first fog bitmap includes the plurality of bitmap regions. Each bitmap region corresponds to one color value. The plurality of bitmap regions and the plurality of first map regions are in one-to-one correspondence. For any bitmap region, the color value of the bitmap region indicates whether fog exists in the first map region corresponding to the bitmap region. The color value of each bitmap region may be 0 or 1. This embodiment of this application does not impose a limitation on this. The terminal can obtain the first fog bitmap of the virtual map related to the virtual scene, so as to obtain the fog at each position on the virtual map during the rendering of the virtual map.

202. In response to a virtual object moving in the virtual scene, the terminal determines an object position of the virtual object on the virtual map based on a scene position of the virtual object in the virtual scene.

In this embodiment of this application, a player can control, through the terminal, the virtual object to move in the virtual scene. When the virtual object moves in the virtual scene, the terminal can obtain the scene position of the virtual object in the virtual scene. Then, the terminal calculates the object position of the virtual object on the virtual map based on the scene position of the virtual object and the foregoing mapping relationship.

203. The terminal updates the color values of the bitmap regions in the first fog bitmap based on the object position, to obtain a second fog bitmap.

In this embodiment of this application, the terminal can determine, according to the object position of the virtual object on the virtual map, a first map region in which the virtual object is currently located and another first map region near the first map region. Then, the terminal can update a color value of a third bitmap region in the first fog bitmap, to obtain the second fog bitmap. The third bitmap region includes the first map region in which the virtual object is currently located and a bitmap region corresponding to the another first map region near the first map region. For any third bitmap region, the terminal updates a color value of the third bitmap region in the first fog bitmap into a color value for indicating that no virtual fog exists.

204. The terminal renders the virtual map based on the second fog bitmap.

In this embodiment of this application, the terminal renders the virtual map according to the color values of the bitmap regions in the second fog bitmap. In the rendering process, for any first map region on the virtual map, the terminal samples, according to the color value of the bitmap region corresponding to the first map region, a color corresponding to the color value, to render the first map region. Correspondingly, some first map regions in the rendered virtual map are dark, presenting a virtual fog effect. Some first map regions are bright, presenting a virtual fog clearing effect.

An embodiment of this application provides a virtual map rendering method. Whether virtual fog exists in each first map region on a virtual map is indicated in a form of a binary value, so that a data volume of a first fog bitmap for indicating whether virtual fog exists in each position on the entire virtual map is small, and resources occupied for storing the first fog bitmap are saved. In addition, a color value of a bitmap region in the first fog bitmap can be dynamically updated according to a position of the virtual object in the virtual scene after the virtual object moves, so that dynamic changes of the virtual fog with the movement of the virtual object can be presented, to enhance a presentation effect on the virtual fog. In addition, since the data volume of the fog bitmap of the virtual map is small, when the virtual map is rendered through the second fog bitmap obtained by update, a data volume being processed is small, thereby improving the efficiency of rendering the virtual map.

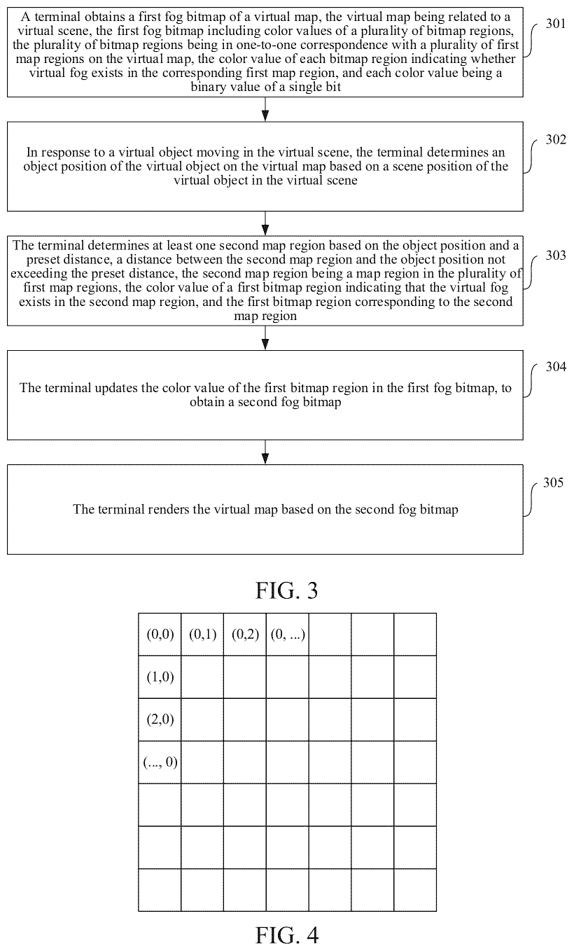

FIG. 3 is a flowchart of a virtual map rendering method according to an embodiment of this application. Referring to FIG. 3, this embodiment of this application is described by taking the method being performed by a terminal as an example. The virtual map rendering method includes the following steps:

301. The terminal obtains a first fog bitmap of a virtual map, the virtual map being related to a virtual scene, the first fog bitmap including color values of a plurality of bitmap regions, the plurality of bitmap regions being in one-to-one correspondence with a plurality of first map regions on the virtual map, the color value of each bitmap region indicating whether virtual fog exists in the corresponding first map region, and each color value being a binary value of a single bit.

In this embodiment of this application, the virtual scene is a virtual scene in which a virtual object currently controlled by a player is located. The virtual map is divided into the plurality of first map regions in advance. The virtual map may be divided into the regions by the terminal, or may be divided into the regions by a server. This embodiment of this application does not impose a limitation on this. This embodiment of this application is described by taking the terminal as an example. For any first map region on the virtual map, the terminal can use a binary value of a single bit to indicate whether virtual fog exists in the first map region. The binary values corresponding to the plurality of first map regions form the first fog bitmap. The first fog bitmap includes the plurality of bitmap regions. Each bitmap region corresponds to one binary value. Correspondingly, the plurality of bitmap regions in the first fog bitmap and the plurality of first map regions on the virtual map are in one-to-one correspondence. Each bitmap region indicates whether virtual fog exists in the corresponding first map region. The binary values in the first fog bitmap can be mapped to colors, so that in the process of rendering the virtual map, the terminal can sample the colors to which the binary values in the first fog bitmap are mapped, to render the virtual map. Therefore, the binary values in the fog bitmap can be referred to as color values.

For any first map region, the color value of the bitmap region corresponding to the first map region may be a first value or a second value. This embodiment of this application does not impose a limitation on this. The first value indicates that virtual fog exists in the corresponding first map region. The second value indicates that no virtual fog exists in the corresponding first map region. In other words, when the color value of the bitmap region corresponding to the first map region is the first value, a fog state of the first map region is a locked state. When the color value of the bitmap region corresponding to the first map region is the second value, a fog state of the first map region is an unlocked state. The first value is 0, and the second value is 1. Alternatively, the first value is 1, and the second value is 0. This embodiment of this application does not impose a limitation on this.

In the process that the terminal renders the virtual map, the terminal obtains the first fog bitmap of the virtual map related to the virtual scene. The process that the terminal renders the virtual map can occur in a process that the virtual object enters the virtual scene for the first time, or can occur in a process that the virtual object moves in the virtual scene. This embodiment of this application does not impose a limitation on this. Before the virtual object enters the virtual scene for the first time, the fog state of each first map region on the virtual map is the locked state. Namely, the color value of each bitmap region in the first fog bitmap of the virtual map is the first value. When the virtual object moves in the virtual scene, the virtual fog in first map regions through which the virtual object passes through is gradually unlocked. Namely, the color values corresponding to the first map regions through which the virtual object passes change from the first value to the second value, and the color values corresponding to first map regions that the virtual object does not pass through are still the first value. “Pass” means a first map region that the virtual object has reached, or means a first map region that the virtual object has reached and a first map region nearby. This embodiment of this application does not impose a limitation on this.

The terminal can divide the virtual map based on a resolution of the virtual map. Alternatively, the terminal divides the virtual map based on a scene complexity of the virtual scene at each position on the virtual map. Alternatively, the terminal divides the virtual map based on a task difficulty of a virtual task at each position on the virtual map. This embodiment of this application does not limit a mode for dividing the virtual map. The sizes and shapes of the first map regions obtained by division may be the same or different. This embodiment of this application does not impose a limitation on this.

In some embodiments, the terminal can divide the virtual map based on a resolution of the virtual map. Correspondingly, a process that the terminal divides the virtual map is as follows: The terminal determines a division size of a single first map region based on the resolution of the virtual map and a preset division rule. Then, the terminal divides the virtual map into the plurality of first map regions based on the division size. The preset division rule indicates that a size ratio of the single first map region to the virtual map after division is within a preset range. The resolution of the virtual map is determined based on a size of the virtual map. This embodiment of this application does not limit the preset range. In the solution provided in this embodiment of this application, the virtual map is divided according to the resolution of the virtual map and the preset division rule, so that the size ratio of each first map region to the virtual map after division is within the preset range. This can avoid a decrease, caused by large first map regions obtained by division, in the virtual fog effect due to a significant sudden change between first map regions with virtual fog and first map regions without virtual fog during subsequent rendering of the virtual fog in the virtual map. In addition, this can further avoid occupation of more resources during storage because of a large data volume of the first fog bitmap due to many first map regions with small sizes. It can be learned from the above that the solution provided in this embodiment of this application causes the first map regions obtained by division to have appropriate sizes, which not only facilitates enhancing the subsequent virtual fog rendering effect, but also saves a storage space.

For example, FIG. 4 is a schematic diagram of division of a virtual map according to an embodiment of this application. Referring to FIG. 4, FIG. 4 exemplarily shows a division effect of a part of the virtual map. The virtual map is a virtual map with a resolution of 12800*3200. The terminal divides the virtual map into a plurality of first map regions with a size of 100*100 according to a preset division rule. A quantity of the first map regions is 128*32. Each first map region corresponds to one position coordinate. A color value corresponding to each first map region is 1 bit, and a size of a first fog bitmap is 4096 bits in total, namely, the size is 512 bytes. The resolution of the virtual map can be locally stored in the terminal or stored in a server. This embodiment of this application does not impose a limitation on this. An example in which the resolution of the virtual map is stored in the server is taken. The terminal can obtain the resolution of the virtual map from the server according to a map identification (Group ID) of the virtual map, to divide the virtual map. The server can further store a path and zoom scale of a small map in a virtual scene, a path and coordinates of an origin of the virtual map, a movement proportion of a virtual object, the size of each first map region, and the like. This embodiment of this application does not impose a limitation on this. The small map is a small map displayed at a position on a screen of the terminal when the virtual object moves in the virtual scene. The path of the small map means a path displayed on the small map, and prompts a route for a player.

In some embodiments, the terminal divides the virtual map based on a scene complexity corresponding to each position on the virtual map. Correspondingly, a process that the terminal divides the virtual map is as follows: The terminal obtains the scene complexity corresponding to each position on the virtual map. Then, the terminal divides the virtual map into the plurality of first map regions based on the scene complexity corresponding to each position on the virtual map. The scene complexity corresponding to the position is configured for representing a quantity of virtual matters in the virtual scene at the position. Namely, the scene complexity corresponding to the position is configured for representing the quantity of the virtual matters located at the position in the virtual scene. The virtual matters may be virtual props, virtual buildings, virtual plants, or the like. This embodiment of this application does not impose a limitation on this. A larger quantity of the virtual matters in the virtual scene indicates a higher scene complexity of the virtual scene. A smaller quantity of the virtual matters in the virtual scene indicates a lower scene complexity of the virtual scene. The size of each first map region is in negative correlation to the scene complexity. Namely, a higher scene complexity indicates that the first map region has a smaller size. A lower scene complexity indicates that the first map region has a larger size. According to the solution provided in this embodiment of this application, clearing of the virtual fog in a region close to the virtual object can be presented subsequently according to a position of the virtual object in the virtual scene, and the virtual map is divided according to the scene complexity of the virtual scene at each position on the virtual map, so that first map regions with large sizes can be obtained by division when there are a few of virtual matters in the virtual scene, and the clearing of the virtual fog in the large first map regions can be presented at a time when the virtual object is located in the virtual scene. Thus, a player can see more virtual scenes at a time, thereby quickly improving the human-computer interaction efficiency through a current virtual scene, which is conductive to enhancing the player experience.

The terminal can gradually expand a detection range in a preset direction, starting from a preset position on the virtual map, and detect virtual matters within the detection range as the detection range is expanded. When a quantity of the virtual matters within the detection range reaches a preset quantity, the terminal divides the range starting from the preset position into one first map region. Then, the terminal continues to gradually detect virtual matters in the preset direction.

In some embodiments, the terminal divides the virtual map based on a task difficulty of a virtual task at each position on the virtual map. Correspondingly, a process that the terminal divides the virtual map is as follows: The terminal obtains the task difficulty of the virtual task at each position on the virtual map. Then, the terminal divides the virtual map into a plurality of first map regions based on the task difficulty of the virtual task at each position on the virtual map. The task difficulty may be an artificial intelligence object, for example, a non-player character (NPC), to be defeated by the virtual object. Or, the task difficulty may be virtual props that the virtual object needs to gather. This embodiment of this application does not impose a limitation on this. The size of each first map region is in positive correlation with the task difficulty. According to the solution provided in this embodiment of this application, clearing of the virtual fog in a region close to the virtual object can be presented subsequently according to a position of the virtual object in the virtual scene, and the virtual map is divided according to the task complexity of the virtual scene at each position on the virtual map, so that first map regions with large sizes can be obtained by division when the task difficulty of the virtual task is high, and the clearing of the virtual fog in the large first map regions can be presented at a time when the virtual object performs the virtual task. Thus, a player can see more virtual scenes at a time, thereby facilitating the player to perform the virtual task and improving the human-computer interaction efficiency, which is conductive to enhancing the player experience.

The first fog bitmap may be stored in the server, or may be locally stored in the terminal. This embodiment of this application does not impose a limitation on this. An example in which the first fog bitmap is stored in the server is taken. Each time before the terminal renders the virtual map, the terminal can pull the first fog bitmap of the virtual map from the server. A storage format of the first fog bitmap is as follows:

```
  //set a first fog bitmap
  message CSReqSetBigWorldMapData
  {
  uint32 AreaID = 1; //set identifications of first map regions on a virtual map
  bytes MapData = 2; //set color values corresponding to the first map regions,
and store the color values in a form of a binary value
  }
```

302. In response to a virtual object moving in the virtual scene, e terminal determines an object position of the virtual object on the virtual map based on a scene position of the virtual object in the virtual scene.

In this embodiment of this application, when the virtual object moves in the virtual scene, the terminal can obtain the scene position of the virtual object in the virtual scene. The virtual scene may be a two-dimensional virtual scene, a 2.5-dimensional virtual scene, or a three-dimensional virtual scene. This embodiment of this application does not impose a limitation on this. The terminal maps the scene position of the virtual object to the virtual map based on a mapping relationship between the virtual scene and the virtual map, to obtain the object position of the virtual object on the virtual map. This embodiment of this application does not impose a limitation on the foregoing mapping relationship.

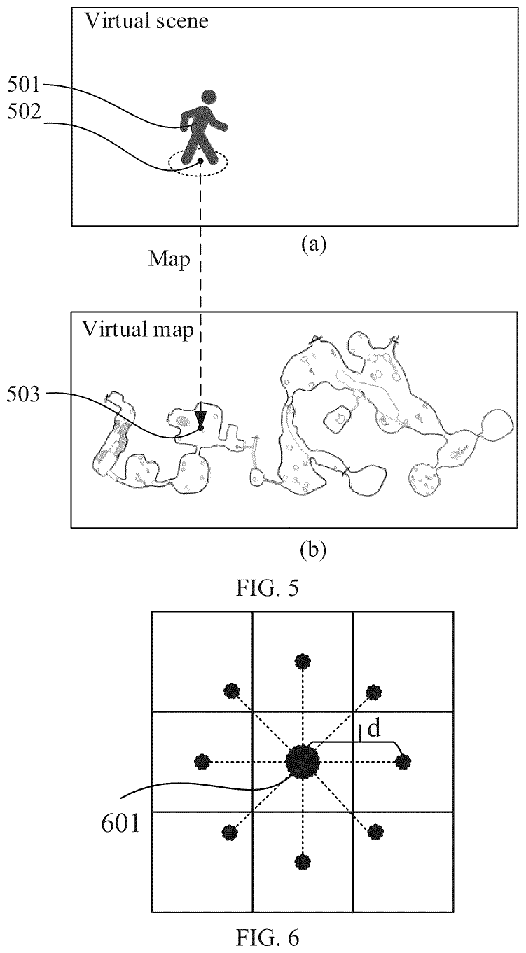

For example, FIG. 5 is a schematic diagram of determining an object position according to an embodiment of this application. FIG. 5(a) exemplarily shows a scene position 502 of a virtual object 501 in a virtual scene. Then, the terminal maps the scene position 502 to a virtual map, to obtain an object position 503 of the virtual object on the virtual map. Refer to FIG. 5(b). In some embodiments, the virtual scene is a three-dimensional virtual scene, and the virtual map is a two-dimensional map. The terminal may determine the object position 503 to be (x, y) based on the scene position 502 (x, y, z).

303: The terminal determines at least one second map region based on the object position and a preset distance, a distance between the second map region and the object position not exceeding the preset distance, the second map region being a map region in the plurality of first map regions, the color value of a first bitmap region indicating that virtual fog exists in the second map region, and the first bitmap region corresponding to the second map region.

In this embodiment of this application, the terminal determines, by using the object position as a center, the plurality of first map regions spaced apart from the object position by a distance that does not exceed the preset distance. The distance between each first map region and the object position may be a distance between a center of the first map region and the object position, or may be a distance between a point on a boundary of each first map region and the object position. This embodiment of this application does not impose a limitation on this. Then, the terminal selects, based on the first fog bitmap, a first map region having virtual fog from the plurality of first map regions spaced apart from the object position by the distance that does not exceed the preset distance, and uses the selected first map region as a second map region. Namely, the terminal selects, based on the first fog bitmap from the plurality of first map regions spaced apart from the object position by the distance that does not exceed the preset distance, a first map region corresponding to a bitmap region with the color value being the first value, and uses the selected first map region as a second map region. The first bitmap region is a bitmap region corresponding to the second map region in the first fog bitmap. For the plurality of first map regions on the virtual map, a map region, spaced apart from the object position by a distance that does not exceed the preset distance, in the plurality of first map regions is referred to as a second map region.

For example, FIG. 6 is a schematic diagram of determining a second map region according to an embodiment of this application. Referring to FIG. 6, each grid is a first map region obtained after division. The terminal can detect that there are totally nine first map regions spaced apart from an object position 601 by a distance that is less than a preset distance d. Then, based on the first fog bitmap, the terminal finds out a first map region corresponding to a bitmap region with a color value being the first value from the nine first map regions in FIG. 6, and uses the first map region as a second map region.

Based on finding out a plurality of first map regions spaced apart from the object position by distances that do not exceed the preset distance, the terminal can further screen the plurality of first map regions based on a preset path on the virtual map or a virtual matter in the virtual scene, so as to subsequently use a first map region with virtual fog as a second map region from the selected first map regions. The preset path on the virtual map is an entire route that is provided for a player to participate in a virtual task. The player can control the virtual object to move along the preset path, to perform the virtual task.

In some embodiments, the terminal can further screen the plurality of first map regions based on the preset path on the virtual map. Correspondingly, the terminal selects a preset quantity of first map region from the plurality of first map regions based on positions of the plurality of first map regions and a position of the preset path. A distance between the selected first map region and the preset path is less than a first threshold. This embodiment of this application does not impose a limitation on the preset quantity and the first threshold. According to the solution provided in this embodiment of this application, the second map region is subsequently determined from the selected first map region, and a fog state of the second map region is set to a locked state. First map regions near the object position are screened according to the preset path on the virtual map, to obtain a first map region closer to the preset path. Thus, it is conductive to subsequently preferentially closing the virtual fog in the first map region closer to the preset path. In this way, a player can determine the position of the preset path, to avoid the virtual object controlled by the player from deviating from the preset path. Therefore, it is conductive for the virtual object to perform the virtual task along the preset path, and can improve the human-computer interaction efficiency, thereby enhancing the player experience.

In some embodiments, the terminal can further screen the plurality of first map regions based on the virtual matter in the virtual scene. Correspondingly, the terminal detects whether a virtual matter exists in each first map region in the plurality of first map regions. Then, the terminal selects a preset quantity of first map region from the plurality of first map regions, and the virtual matter exists in the selected first map region. In the solution provided in this embodiment of this application, the second map region is subsequently determined from the selected first map region, and a fog state of the second map region is set to an unlocked state. First map regions near the object position are screened according to the virtual matter in the virtual scene, to obtain the first map region in which the virtual matter exists. Thus, it is conductive to subsequently preferentially closing the virtual fog in the first map region in which the virtual matter exists, to display the virtual matter in time, thereby enriching modes for displaying the virtual matter. A player is attracted by the virtual matter to move freely in the virtual scene, which can increase the enthusiasm of the player in participating in the virtual task.

The virtual matter may be an ornamental virtual plant, or a virtual prop, a virtual building, or the like related to the virtual task. This embodiment of this application does not impose a limitation on this. Different virtual matters have different priorities. A priority of a virtual object is in positive correlation to a degree of contribution of the virtual matter to the virtual task. Correspondingly, in the process of screening the first map regions, the terminal may select, from the first map region in which the virtual matter exists, a first map region with a priority of the virtual object reaching a second threshold. This embodiment of this application does not impose a limitation on the second threshold. In the solution provided in this embodiment of this application, the second map region is subsequently determined from the selected first map region, and a fog state of the second map region is set to an unlocked state. First map regions near the object position are screened according to the priorities of the virtual matters in the virtual scene, which is conductive to subsequently preferentially closing virtual fog in a first map region in which a virtual matter has a high priority, so that a player can see a virtual matter having a large degree of contribution to a virtual task. It facilitates the player to perform the virtual task and improves the human-computer interaction efficiency, thereby increasing the enthusiasm of the player in participating the virtual task.

304. The terminal updates the color value of the first bitmap region in the first fog bitmap, to obtain the second fog bitmap.

In this embodiment of this application, the terminal updates the first value of the first bitmap region in the first fog bitmap to the second value. Namely, the terminal updates the fog state of the at least one second map region from the locked state to the unlocked state. The terminal obtains the second fog bitmap based on the updated color value of the at least one second map region and other non-updated color values.

In some embodiments, the terminal may upload the second fog bitmap to the server, and the server stores the fog bitmap after update. Storing a fog bitmap through the server can improve the security of the fog bitmap, and avoid an unspecified situation that to improve a success rate of a virtual task, a player privately modifies a color value in the fog bitmap by using a plug-in or another factor to view more virtual maps, so that it is conductive to improving fairness of participation in the virtual task. In addition, when a player accidentally quits a game with the virtual map due to a network fault or another reason, when the player enters the game again, the terminal can render the virtual map according to the fog bitmap in the server, to restore the fog state on the virtual map before quit, namely, restore a game progress before quit, so that the player continues to participate in the game, thereby enhancing game experience of the player.

The terminal can upload a fog bitmap to the server every preset period. Namely, the terminal can first store the updated second fog bitmap into a buffer space or a memory space, and upload the second fog bitmap to the server when current time reaches the preset period. This embodiment of this application does not impose a limitation on the preset period.

305. The terminal renders the virtual map based on the second fog bitmap.

In this embodiment of this application, the terminal renders the virtual map according to the color values of the plurality of bitmap regions in the second fog bitmap, to present a fog effect on the virtual map. The color values in the second fog bitmap are classified into two types: a first value and a second value. The first value indicates that virtual fog exists in the corresponding first map region. Namely, the first value indicates that the fog state in the corresponding first map region is the locked state. The second value indicates that no virtual fog exists in the corresponding first map region. Namely, the first value indicates that the fog state in the corresponding first map region is the unlocked state. Correspondingly, the process that the terminal renders the virtual map based on the second fog bitmap is as follows: For any bitmap region in the second fog bitmap, when the color value of the bitmap region is the first value, the terminal renders the virtual fog that exists in a first map region, which corresponds to the bitmap region, on the virtual map. When the color value of the bitmap region is the second value, the terminal renders a virtual map icon that exists in a first map region, which corresponds to the bitmap region, on the virtual map.

In the process of rendering the virtual map, the terminal can map the first value into a color of the virtual fog. Then, during the rendering of the first map region corresponding to the first value, the terminal may sample the color mapped from the first value for rendering, to obtain the virtual fog in the first map region. The color of the virtual fog may be black, yellow, or the like. This embodiment of this application does not impose a limitation on this. The terminal may map the second value to a white color. Then, during the rendering of the first map region corresponding to the second value, the terminal may perform rendering by sampling the white color. Since the sampled white color does not block textures of the virtual map itself, the terminal can obtain the virtual map icon that exists in the first map region. The virtual map icon may be an icon of a virtual task, an icon of a virtual camp, an icon of a virtual campfire, or the like. This embodiment of this application does not impose a limitation on this. In the solution provided in this embodiment of this application, the fog effect on the virtual map is rendered by sampling the colors mapped from the color values in the second fog bitmap, so that the operation is simple, and the virtual map rendering efficiency can be improved.

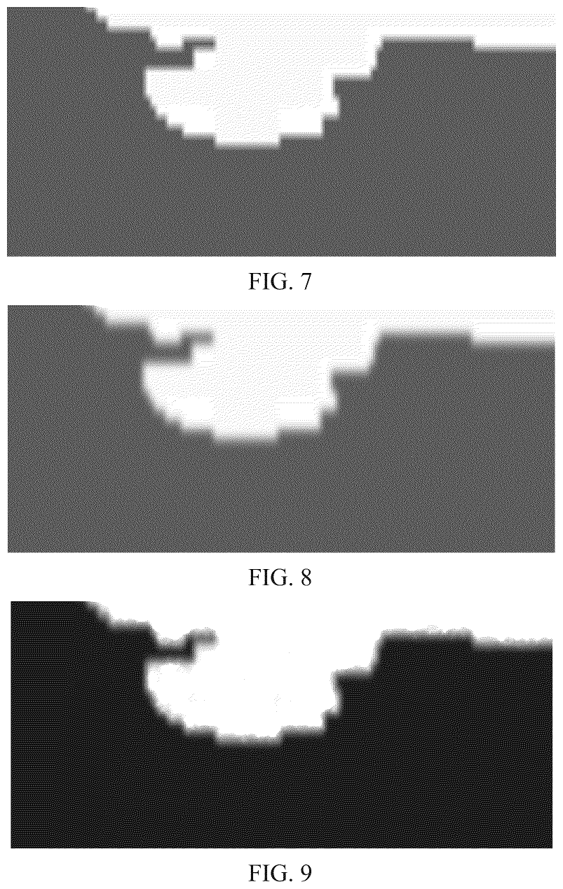

FIG. 7 is a schematic diagram of a second fog bitmap according to an embodiment of the present disclosure. Referring to FIG. 7, a virtual fog is black. The terminal maps the first value into a black color and maps the second value into a white color. Then, the terminal samples the colors mapped from the color values of the bitmap regions in the second fog bitmap, to render the virtual map, thus achieving a fog effect on the virtual map. A boundary line between the black color and the white color in FIG. 7 is a boundary of the virtual fog on the virtual map.

If the division precision of the virtual map is low, namely, if each first map region has a large size, the colors mapped from the color values in the second fog bitmap are directly sampled, and a fog unlocking effect with outstanding pixels can be presented on the virtual map. The second fog bitmap in FIG. 7 is taken as an example. There is a boundary line with outstanding pixels between the black color and the white color in the second fog bitmap in FIG. 7, so that the obtained virtual fog also has a similar boundary. Similar to gas, real fog is not likely to have an outstanding boundary. Therefore, the fog effect achieved based on the second fog bitmap in FIG. 7 is not good enough.

To enhance the virtual fog rendering effect, in this embodiment of this application, the second fog bitmap may be interpolated, to optimize the boundary line formed by the colors to mapped from the different color values in the second fog bitmap. Correspondingly, the terminal interpolates the second fog bitmap based on the color values of the bitmap regions in the second fog bitmap, to obtain a third fog bitmap. Then, the terminal renders the virtual map based on the third fog bitmap. The terminal may interpolate the second fog bitmap by using a bicubic algorithm. This embodiment of this application does not impose a limitation on the interpolation algorithm used by the terminal. The third fog bitmap includes three types of values, such as a first value, a second value, and a plurality of third values. The third values are obtained by interpolating the first value and the second value in the second fog bitmap. The third values are values between the first value and the second value. Colors mapped from the third values are between a color mapped from the first value and a color mapped from the second value. In the solution provided in this embodiment of this application, the fog bitmap is interpolated, so that differences between the color values of the bitmap regions that have different color values and are adjacent to each other in the fog bitmap are reduced. The virtual map is rendered by using the interpolated fog bitmap, so that the boundary of the virtual fog on the virtual map presents a gradient transition effect, which is more in line with an expression form of the real fog, thus enhancing the virtual fog rendering effect.

FIG. 8 is a schematic diagram of a third fog bitmap according to an embodiment of the present disclosure. Referring to FIG. 8, the terminal maps the first value into a black color, maps the second value into a white color, and maps the plurality of third values into colors between the black color and the white color. For any third value, if the third value is closer to the first value, the color mapped from the third value is blacker. If the third value is closer to the second value, the color mapped from the third value is whiter. It can be seen from FIG. 8 that a boundary line between the black color and the white color in the third fog bitmap presents a gradient transition effect. Then, the terminal samples the colors mapped from the color values of the bitmap regions in the third fog bitmap, to render the virtual map, thus causing the boundary of the virtual fog on the virtual map to present the gradient transition effect.

In the process of interpolating the second fog bitmap, the terminal can directly interpolate the entire second fog bitmap. Alternatively, the terminal can further interpolate a color value of a boundary region in the second fog bitmap. The color value of the boundary region is different from the color value of at least one second bitmap region, and the second bitmap region is adjacent to the boundary region. Namely, the boundary region includes at least one bitmap region that has a color value different from the color value of the boundary region and is adjacent to the boundary region. Correspondingly, the process that the terminal interpolates the second fog bitmap is as follows: The terminal determines a plurality of boundary regions based on the color values of the bitmap regions in the second fog bitmap. Then, for any boundary region, the terminal determines, based on a position of the boundary region and an interpolation algorithm, a plurality of reference regions related to the boundary region. Then, the terminal interpolates the color value of the boundary region based on color values of the plurality of reference regions and the interpolation algorithm, to obtain the third fog bitmap. Each boundary region is a bitmap region, which has a color value different from the color value of an adjacent bitmap region, in the plurality of bitmap regions. For each boundary region, a bitmap region adjacent to the boundary region in the second fog bitmap is referred to as a second bitmap region. The reference regions are other bitmap regions near the boundary region. For example, the reference regions are adjacent to the boundary region, or a distance between each reference region and the boundary region is less than a threshold.

In the solution provided in this embodiment of this application, by interpolating the color values of the boundary regions in the second fog bitmap only, a data volume processed in the interpolation process is reduced. This can reduce the running consumption, and can further improve the fog bitmap processing efficiency, thereby improving the virtual map rendering efficiency.

In some embodiments, the terminal can further process a fog bitmap by using a noise map mixing technology, to optimize a boundary line formed by colors mapped from different color values in the second fog bitmap. The terminal can directly add noise to the second fog bitmap. Alternatively, the terminal can further add noise based on the interpolation on the second fog bitmap. Namely, the terminal can add noise to the third fog bitmap. This embodiment of this application does not impose a limitation on this. Correspondingly, the terminal adds the noise to the third fog bitmap based on a noise map, to obtain a fourth fog bitmap. Then, the terminal renders the virtual map based on the fourth fog bitmap. The noise map may be obtained based on Perline noise, or may be obtained based on Worley noise (a type of point noise). This embodiment of this application does not impose a limitation on this. The terminal processes the color values in the third fog bitmap based on a pixel value in the noise map. In the solution provided in this embodiment of this application, since real fog is similar to gas, the real fog is unlikely to be gathered, and a small part will fly to another place. By adding noise to a fog bitmap, the color values of the bitmap regions in the fog bitmap are random. For example, the color value of a bitmap region between a plurality of bitmap regions having the same color values is different. Rendering the virtual map through the fog bitmap with the noise makes a more hierarchical gradient change effect presented at the boundary of the virtual fog on the virtual map, and causes a small amount of virtual fog to appear in a first map region in which the virtual fog has been unlocked, which is more in line with a representation form of real fog, and enhances the virtual fog rendering effect.

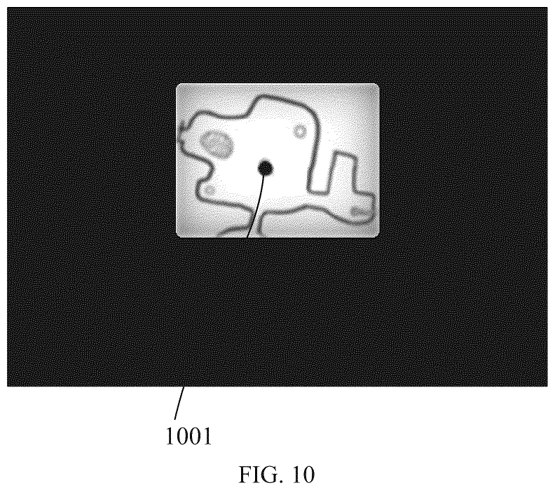

FIG. 9 is a schematic diagram of a fourth fog bitmap according to an embodiment of the present disclosure. Referring to FIG. 9, a boundary line between a black color and a white color in the fourth fog bitmap presents a more hierarchical gradient transition effect. In addition, there is a black part in a white region in the fourth fog bitmap. Namely, there is still a small amount of virtual fog in a region in which the virtual fog has been unlocked, which is more in line with an expression form of the real fog.

The terminal may render the virtual map through the fourth fog bitmap. FIG. 10 is a schematic diagram of a virtual map according to an embodiment of this application. Referring to FIG. 10, a black region is a region in which virtual fog is locked. A white region is a region in which virtual fog has been unlocked. A boundary line between the black region and the white region presents a gradient transition effect, which is more hierarchical and is in line with an expression form of real fog. The white region may change as an object position 1001 of a virtual object changes. For example, when the virtual object moves, the terminal may unlock, according to the object position 1001, virtual fog around the object position 1001, to show more virtual maps to a player. If a virtual map icon exists in a first map region in which virtual fog has been unlocked, the terminal may directly display the virtual map icon.

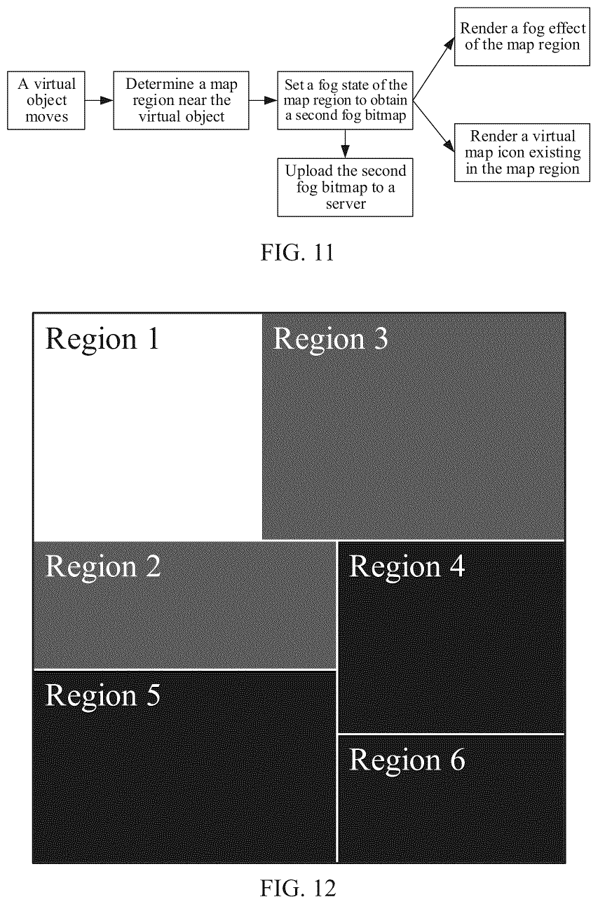

To describe the rendering process of the virtual map more clearly, the rendering process is further described below with reference to the accompanying drawings. FIG. 11 is a flowchart of rendering a virtual map according to an embodiment of this application. Referring to FIG. 11, in response to a virtual object moving in a virtual scene, the terminal determines a map region near the virtual object according to an object position of the virtual object on the virtual map. Then, the terminal updates the color values of the bitmap regions corresponding to the map regions in the first fog bitmap, to obtain a second fog bitmap. Namely, the terminal sets a fog state of a map region in which virtual fog is locked to an unlocked state. Then, the terminal renders the virtual map based on the second fog bitmap. In the rendering process, the terminal obtains virtual fog on the virtual map, and obtains a virtual map icon in a region without virtual fog. The terminal may further upload the updated second fog bitmap to the server.

In some embodiments, the virtual map further includes a plurality of third map regions. Each third map region includes a plurality of first map regions. The third map regions may be related to a virtual task, similar to virtual rooms. The virtual object can enter different third map regions in sequence, to perform the virtual task. The terminal can display the third map regions on the virtual map according to an execution state of the virtual task. Correspondingly, for any third map region, the terminal updates a color value corresponding to the third map region in a fifth fog bitmap when the virtual object completes a virtual task corresponding to the third map region. Then, the terminal obtains a contour of the third map region on the virtual map based on the updated fifth fog bitmap.

The fifth fog bitmap includes color values of a plurality of bitmap regions. The plurality of bitmap regions and the plurality of third map regions on the virtual map are in one-to-one correspondence. The color value of each bitmap region indicates a fog state of virtual fog in the corresponding third map region. The fog state includes an unlocked state, a locked state, and a semi-unlocked state. The unlocked state indicates that no virtual fog exists in the corresponding third map region. The locked state indicates that virtual fog exists in the corresponding third map region. The semi-unlocked state indicates that virtual fog exists in the corresponding third map region, and a blocking effect on the virtual fog is weakened. When the fog state of the virtual fog in the third map region is the semi-unlocked state, the terminal may obtain the contour of the third map region.

The fifth fog bitmap may be stored in a form of an array. A storage format of the fifth fog bitmap may be: repeated unit32 BWCampUnlockList=12. For example, the virtual map is divided into six third map regions. The fifth fog bitmap is a unit array [1, 2, 2, 0, 0, 0]. Where 1 is configured for indicating that the fog state of the virtual fog in the third map region is the unlocked state; 2 is configured for indicating that the fog state of the virtual fog in the third map region is the semi-unlocked state; and 0 is configured for indicating that the fog state of the virtual fog in the third map region is the locked state. Referring to FIG. 12, FIG. 12 is a schematic diagram of a fifth fog bitmap according to an embodiment of the present disclosure. The terminal maps 1 into a white color, maps 2 into a gray color, and maps 0 into a black color.

In some embodiments, quantities of first map regions in different third map regions may be the same or may be different.

For example, the virtual map includes four third map regions. An example in which quantities of the first map regions in the four third map regions are the same is taken. Each third map region includes nine first map regions, namely, the virtual map includes 36 first map regions. The fog bitmap on the virtual map includes four fourth bitmap regions, and each fourth bitmap region includes nine fifth bitmap regions. The four fourth bitmap regions and the four third map regions are in one-to-one correspondence. For a fourth bitmap region and a third map region that have a correspondence relationship, the nine first map regions in the fourth map region and the nine fifth bitmap regions in the third map region are in one-to-one correspondence. The fog map of the virtual map can be represented by using a unit array. For example, the fog map of the virtual map can be represented by a 4×9 matrix, and values in any column in the matrix are the color values of the fifth bitmap regions in one fourth bitmap region, to indicate whether virtual fog exists in the first map regions in the third map region corresponding to the fourth bitmap region.

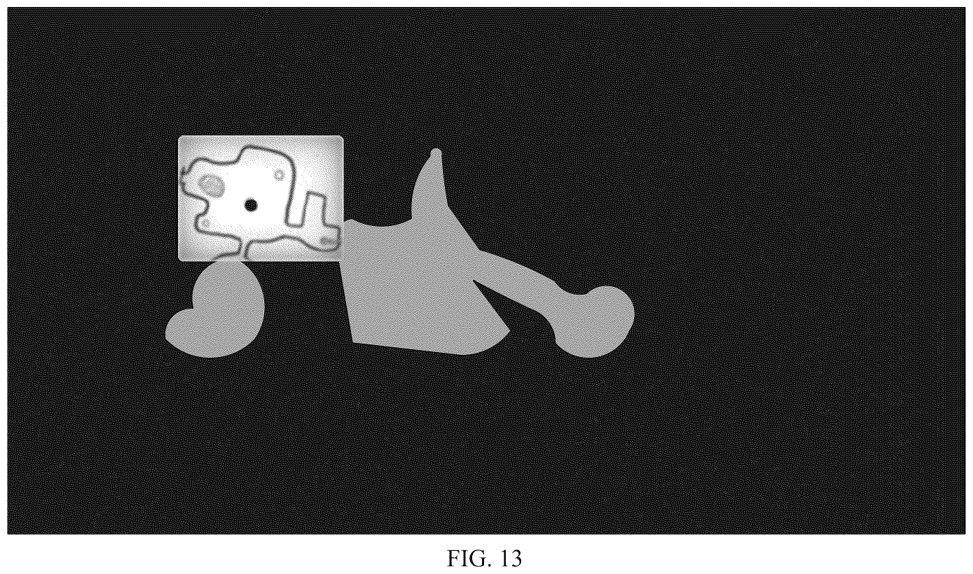

Then, the terminal samples the colors mapped from the color values of the fifth bitmap regions, to render the virtual map, thus achieving a fog effect on the virtual map. For example, FIG. 13 is a schematic diagram of another virtual map according to an embodiment of this application. Referring to FIG. 13, a black region is a region in which virtual fog is locked. A white region is a region in which virtual fog has been unlocked. A gray region is a region in which virtual fog has been semi-unlocked.

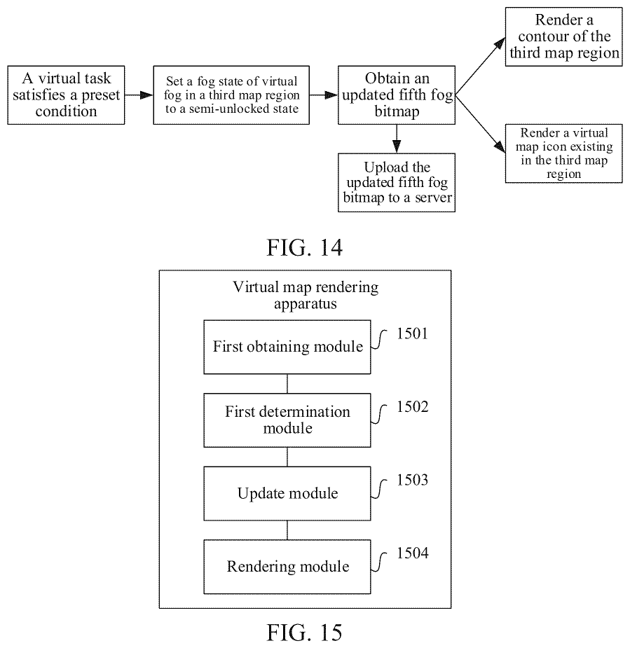

To describe the rendering process of the third map regions in the virtual map more clearly, the rendering process is further described below with reference to the accompanying drawings. FIG. 14 is another flowchart of rendering a virtual map according to an embodiment of this application. Referring to FIG. 14, when a virtual task performed by a virtual object satisfies a preset condition, the terminal updates the color values of the bitmap regions corresponding to the third map regions in the fifth fog bitmap. Namely, the terminal sets a fog state of a map region in which virtual fog is locked to a semi-unlocked state. Then, the terminal renders the virtual map based on the updated fifth fog bitmap. In the rendering process, the terminal obtains contours of the third map regions on the virtual map. In addition, the terminal can further obtain virtual map icons in the third map regions. The terminal can further upload the updated fifth fog bitmap to the server.

An embodiment of this application provides a virtual map rendering method. Whether virtual fog exists in each first map region on a virtual map is indicated in a form of a binary value, so that a data volume of a first fog bitmap for indicating whether virtual fog exists in each position on the entire virtual map is small, and resources occupied for storing the first fog bitmap are saved. In addition, a color value of a bitmap region in the first fog bitmap can be dynamically updated according to a position of the virtual object in the virtual scene after the virtual object moves, so that dynamic changes of the virtual fog with the movement of the virtual object can be presented, to enhance a presentation effect on the virtual fog. In addition, since the data volume of the fog bitmap of the virtual map is small, when the virtual map is rendered through the second fog bitmap obtained by update, a data volume being processed is small, thereby improving the efficiency of rendering the virtual map.

FIG. 15 is a block diagram of a virtual map rendering apparatus according to an embodiment of this application. The virtual map rendering apparatus is configured to perform the steps in the foregoing virtual map rendering method. Referring to FIG. 15, the virtual map rendering apparatus includes: a first obtaining module 1501, a first determination module 1502, an update module 1503, and a rendering module 1504.

The first obtaining module 1501 is configured to obtain a first fog bitmap of a virtual map, the virtual map being related to a virtual scene, the first fog bitmap including color values of a plurality of bitmap regions, the plurality of bitmap regions being in one-to-one correspondence with a plurality of first map regions on the virtual map, the color value of each bitmap region indicating whether virtual fog exists in the corresponding first map region, and each color value being a binary value of a single bit.

The first determination module 1502 is configured to determine, in response to a virtual object moving in the virtual scene, an object position of the virtual object on the virtual map based on a scene position of the virtual object in the virtual scene.

The update module 1503 is configured to update the color values of the bitmap regions in the first fog bitmap based on the object position, to obtain a second fog bitmap.

The rendering module 1504 is configured to render the virtual map based on the second fog bitmap.

An embodiment of this application provides a virtual map rendering apparatus. Whether virtual fog exists in each first map region on a virtual map is indicated in a form of a binary value, so that a data volume of a first fog bitmap for indicating whether virtual fog exists in each position on the entire virtual map is small, and resources occupied for storing the first fog bitmap are saved. In addition, a color value of a bitmap region in the first fog bitmap can be dynamically updated according to a position of the virtual object in the virtual scene after the virtual object moves, so that dynamic changes of the virtual fog with the movement of the virtual object can be presented, to enhance a presentation effect on the virtual fog. In addition, since the data volume of the fog bitmap of the virtual map is small, when the virtual map is rendered through the second fog bitmap obtained by update, a data volume being processed is small, thereby improving the efficiency of rendering the virtual map.

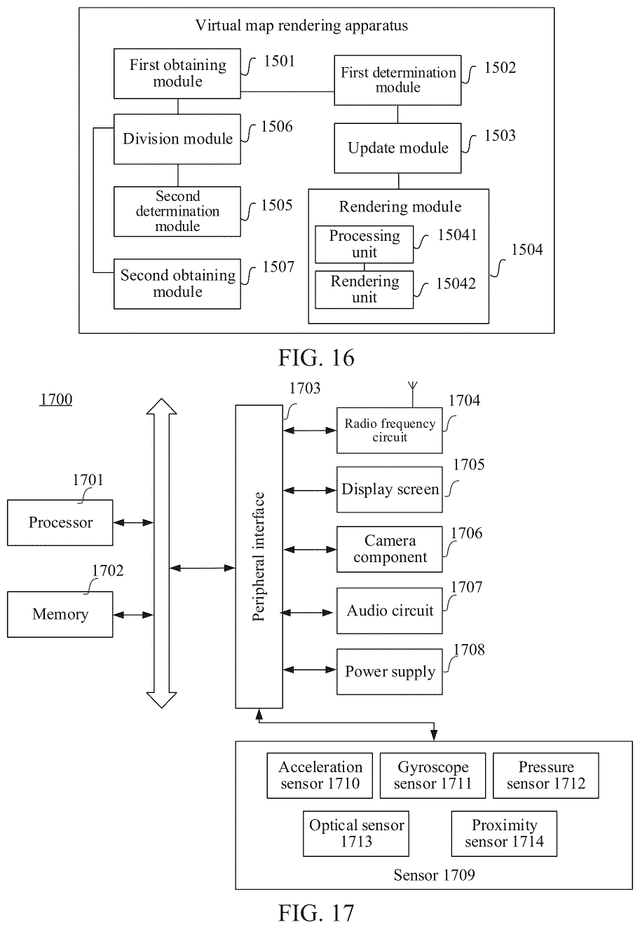

In some embodiments, FIG. 16 is a block diagram of another virtual map rendering apparatus according to an embodiment of this application. Referring to FIG. 16, the update module 1503 is configured to: determine at least one second map region based on the object position and a preset distance, a distance between the second map region and the object position not exceeding the preset distance, the second map region being a map region in the plurality of first map regions, the color value of a first bitmap region indicating that virtual fog exists in the second map region, and the first bitmap region corresponding to the second map region; and update the color value of the first bitmap region in the first fog bitmap, to obtain the second fog bitmap.

In some embodiments, still referring to FIG. 16, the rendering module 1504 is configured to: render, for any bitmap region in the second fog bitmap when the color value of the bitmap region is a first value, the virtual fog that exists in a first map region, which corresponds to the bitmap region, on the virtual map; and render, when the color value of the bitmap region is a second value, a virtual map icon that exists in a first map region, which corresponds to the bitmap region, on the virtual map.

In some embodiments, still referring to FIG. 16, the rendering module 1504 includes:
a processing unit 15041, configured to interpolate the second fog bitmap based on the color values of the bitmap regions in the second fog bitmap, to obtain a third fog bitmap; and
a rendering unit 15042, configured to render the virtual map based on the third fog bitmap.

In some embodiments, still referring to FIG. 16, the processing unit 15041 is configured to: determine a plurality of boundary regions based on the color values of the bitmap regions in the second fog bitmap, color values of the boundary regions being different from the color value of at least one second bitmap region, and the second bitmap region being adjacent to the boundary regions; determine, for any boundary region based on a position of the boundary region and an interpolation algorithm, a plurality of reference regions related to the boundary region; and interpolate the color value of the boundary region based on color values of the plurality of reference regions and the interpolation algorithm, to obtain the third fog bitmap.

In some embodiments, still referring to FIG. 16, the rendering unit 15042 is configured to: add noise to the third fog bitmap based on a noise map, to obtain a fourth fog bitmap; and render the virtual map based on the fourth fog bitmap.

In some embodiments, still referring to FIG. 16, the apparatus further includes:
a second determination module 1505, configured to determine a division size of a single first map region based on a resolution of the virtual map and a preset division rule, the preset division rule indicating that a size ratio of the single first map region to the virtual map after division is within a preset range; and
a division module 1506, configured to divide the virtual map into the plurality of first map regions based on the division size.

In some embodiments, still referring to FIG. 16, the apparatus further includes:
a second obtaining module 1507, configured to obtain a scene complexity corresponding to each position on the virtual map, the scene complexity corresponding to the position being configured for indicating a quantity of virtual matters located at the position in the virtual scene; and
a division module 1506, configured to divide the virtual map into the plurality of first map regions based on the scene complexity corresponding to each position on the virtual map, a size of each first map region being in negative correlation with the scene complexity.

In some embodiments, the virtual map further includes a plurality of third map regions, and each third map region includes the plurality of first map regions.

The update module 1503 is further configured to update, for any third map region, a color value corresponding to the third map region in a fifth fog bitmap when the virtual object completes a virtual task corresponding to the third map region.

The rendering module 1504 is further configured to render a contour of the third map region on the virtual map based on the updated fifth fog bitmap.

In addition, the virtual map rendering apparatus provided in the foregoing embodiment is illustrated with an example of division of the foregoing function modules. In practical application, the foregoing functions may be allocated to and completed by different function modules according to requirements, that is, the internal structure of the apparatus is divided into different function modules, so as to complete all or part of the functions described above. In addition, the virtual map rendering apparatus provided in the foregoing embodiment belongs to the same conception as the embodiment of the virtual map rendering method. For a specific implementation process thereof, reference may be made to the method embodiment. Details are not described herein again.

FIG. 17 is a structural block diagram of a terminal 1700 according to an embodiment of this application. The terminal 1700 may be a portable mobile terminal, for example: a smartphone, a tablet computer, a moving picture experts group audio layer III (MP3) player, a moving picture experts group audio layer IV (MP4) player, a notebook computer, or a desktop computer. The terminal 1700 may alternatively be referred to as another name such as user equipment, a portable terminal, a laptop terminal, or a desktop terminal.

The terminal 1700 generally includes: a processor 1701 and a memory 1702.

The processor 1701 may include one or more processing cores, for example, a 4-core processor or an 8-core processor. The processor 1701 may be implemented in at least one hardware form of a digital signal processor (DSP), a field-programmable gate array (FPGA), and a programmable logic array (PLA). The processor 1701 may alternatively include a main processor and a coprocessor. The main processor is a processor configured to process data in an awake state, and is also referred to as a central processing unit (CPU). The coprocessor is a low power processor configured to process the data in a standby state. In some embodiments, the processor 1701 may be integrated with a graphics processing unit (GPU). The GPU is configured to render and draw content that needs to be displayed on a display screen. In some embodiments, the processor 1701 may further include an artificial intelligence (AI) processor. The AI processor is configured to process computing operations related to machine learning.

The memory 1702 may include one or more computer-readable storage media. The computer-readable storage medium may be non-transient. The memory 1702 may further include a high-speed random access memory and a nonvolatile memory, for example, one or more disk storage devices or flash storage devices. In some embodiments, the non-transient computer-readable storage medium in the memory 1702 is configured to store at least one computer program, and the at least one computer program is configured to be run by the processor 1701 to implement the virtual map rendering method provided in the method embodiments of this application.

In some embodiments, the terminal 1700 may further include: a peripheral interface 1703 and at least one peripheral. The processor 1701, the memory 1702, and the peripheral interface 1703 may be connected through a bus or a signal wire. Each peripheral may be connected to the peripheral interface 1703 through a bus, a signal cable, or a circuit board. Specifically, the peripheral includes: at least one of a radio frequency circuit 1704, a display screen 1705, a camera component 1706, an audio circuit 1707, and a power supply 1708.

The peripheral interface 1703 may be configured to connect the at least one peripheral related to input/output (I/O) to the processor 1701 and the memory 1702. In some embodiments, the processor 1701, the memory 1702, and the peripheral interface 1703 are integrated on the same chip or circuit board. In some other embodiments, any one or two of the processor 1701, the memory 1702, and the peripheral interface 1703 may be implemented on a single chip or circuit board. This embodiment does not impose a limitation on this.

The RF circuit 1704 is configured to receive and transmit an RF signal, also referred to as an electromagnetic signal. The RF circuit 1704 communicates with a communication network and other communication devices through the electromagnetic signal. The RF circuit 1704 converts an electrical signal into an electromagnetic signal for transmission, or converts a received electromagnetic signal into an electrical signal. In some embodiments, the RF circuit 1704 includes: an antenna system, an RF transceiver, one or more amplifiers, a tuner, an oscillator, a digital signal processor, a code and decode chip set, a subscriber identity module card, and the like. The RF circuit 1704 may communicate with another terminal through at least one wireless communication protocol. The wireless communication protocol includes but is not limited to: a world wide web, a metropolitan area network, an intranet, generations of mobile communication networks (2G, 3G, 4G, and 5G), a wireless local area network and/or a wireless fidelity (Wi-Fi) network. In some embodiments, the RF 1704 may further include a circuit related to NFC. This is not limited in this application.

The display screen 1705 is configured to display a user interface (UI). The UI may include a graph, text, an icon, a video, and any combination thereof. When the display screen 1705 is a touch display screen, the display screen 1705 further has a capability of acquiring a touch signal on or above a surface of the display screen 1705. The touch signal may be inputted to the processor 1701 as a control signal for processing. In this case, the display screen 1705 may be further configured to provide a virtual button and/or a virtual keyboard that are/is also referred to as a soft button and/or a soft keyboard. In some embodiments, there may be one display screen 1705 arranged on a front panel of the terminal 1700. In some other embodiments, there may be at least two display screens 1705 which are respectively arranged on different surfaces of the terminal 1700 or are folded. In some other embodiments, the display screen 1705 may be a flexible display screen arranged on a curved surface or a folded surface of the terminal 1700. Even, the display screen 1705 may be further set in a non-rectangular irregular pattern, namely, a special-shaped screen. The display screen 1705 may be prepared by using materials such as a liquid crystal display (LCD), an organic light-emitting diode (OLED), or the like.

The camera component 1706 is configured to capture images or videos. In some embodiments, the camera component 1706 includes a front-facing camera and a rear-facing camera. Generally, the front-facing camera is disposed on the front panel of the terminal, and the rear-facing camera is disposed on a back surface of the terminal. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera component 1706 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 1707 may include a microphone and a speaker. The microphone is configured to acquire sound waves of a user and an environment, and convert the sound waves into an electrical signal to input to the processor 1701 for processing, or input to the radio frequency circuit 1704 for implementing voice communication. For the purpose of stereo acquisition or noise reduction, there may be a plurality of microphones, respectively arranged at different portions of the terminal 1700. The microphone may further be an array microphone or an omni-directional acquisition type microphone. The speaker is configured to convert electrical signals from the processor 1701 or the RF circuit 1704 into sound waves. The speaker may be a conventional film speaker, or may be a piezoelectric ceramic speaker. When the speaker is the piezoelectric ceramic speaker, the speaker not only can convert an electrical signal into acoustic waves audible to a human being, but also can convert an electrical signal into acoustic waves inaudible to a human being, for ranging and other purposes. In some embodiments, the audio circuit 1707 may further include an earphone jack.

The power supply 1708 is configured to supply power to components in the terminal 1700. The power supply 1708 may be an alternating current, a direct current, a primary battery, or a rechargeable battery. When the power supply 1708 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the terminal 1700 further includes one or more sensors 1709. The one or more sensors 1709 include, but are not limited to: an acceleration sensor 1710, a gyroscope sensor 1711, a pressure sensor 1712, an optical sensor 1713, and a proximity sensor 1714.

The acceleration sensor 1710 may detect a magnitude of acceleration on three coordinate axes of a coordinate system established with the terminal 1700. For example, the acceleration sensor 1710 may be configured to detect components of gravity acceleration on the three coordinate axes. The processor 1701 may control, according to a gravity acceleration signal acquired by the acceleration sensor 1710, the touch display screen 1705 to display the UI in a landscape view or a portrait view. The acceleration sensor 1710 may be further configured to acquire motion data of a game or a user.

The gyroscope sensor 1711 may detect a body direction and a rotation angle of the terminal 1700. The gyroscope sensor 1711 may cooperate with the acceleration sensor 1710 to acquire a 3D action by the user on the terminal 1700. The processor 1701 may implement the following functions according to the data acquired by the gyroscope sensor 1711: motion sensing (such as changing the UI according to a tilt operation of the user), image stabilization at shooting, game control, and inertial navigation.

The pressure sensor 1712 may be arranged at a side frame of the terminal 1700 and/or a lower layer of the display screen 1705. When the pressure sensor 1712 is arranged at the side frame of the terminal 1700, a holding signal of the user on the terminal 1700 may be detected. The processor 1701 performs left and right hand recognition or a quick operation according to the holding signal acquired by the pressure sensor 1712. When the pressure sensor 1712 is disposed on the low layer of the touch display screen 1705, the processor 1701 controls, according to a pressure operation of the user on the display screen 1705, an operable control on the UI. The operable control includes at least one of a button control, a scroll-bar control, an icon control, and a menu control.

The optical sensor 1713 is configured to acquire ambient light intensity. In an embodiment, the processor 1701 may control the display brightness of the display screen 1705 according to the ambient light intensity acquired by the optical sensor 1713. Specifically, when the ambient light intensity is relatively high, the display brightness of the display screen 1705 is increased. When the ambient light intensity is relatively low, the display brightness of the touch display screen 1705 is decreased. In another embodiment, the processor 1701 may further dynamically adjust a camera parameter of the camera component 1706 according to the ambient light intensity acquired by the optical sensor 1713.

The proximity sensor 1714, also referred to as a distance sensor, is generally arranged on the front panel of the terminal 1700. The proximity sensor 1714 is configured to acquire a distance between the user and the front surface of the terminal 1700. In an embodiment, when the proximity sensor 1714 detects that the distance between the user and the front surface of the terminal 1700 gradually decreases, the display screen 1705 is controlled by the processor 1701 to switch from a screen-on state to the screen-off state. When the proximity sensor 1714 detects that the distance between the user and the front surface of the terminal 1700 gradually increases, the display screen 1705 is controlled by the processor 1701 to switch from the screen-off state to the screen-on state.

A person skilled in the art may understand that the structure shown in FIG. 17 constitutes no limitation on the terminal 1700, and the terminal may include more or fewer components than those shown in the figure, or some components may be combined, or a different component deployment may be used.

An embodiment of this application further provides a non-transitory computer-readable storage medium, having at least one computer program stored therein. The at least one computer program is loaded and run by a processor of a computer device to implement operations performed by the computer device in the virtual map rendering method of the foregoing embodiment. For example, the computer-readable storage medium may be a read-only memory (ROM), a random access memory (RAM), a compact disc ROM (CD-ROM), a magnetic tape, a floppy disk, an optical data storage device, or the like.

An embodiment of this application further provides a computer program product, including computer program code. The computer program is stored in a computer-readable storage medium. A processor of a computer device reads the computer program from the computer-readable storage medium and runs the computer program, causing the computer device to perform the virtual map rendering method provided in the foregoing various implementations.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules. Moreover, each module or unit can be part of an overall module or unit that includes the functionalities of the module or unit. The foregoing descriptions are merely embodiments of this application, but are not intended to limit this application. Any modification, equivalent replacement, or improvement made within the spirit and principle of this application shall fall within the protection scope of this application.

What is claimed is:

1. A virtual map rendering method performed by a computer device, the method comprising:
obtaining a first fog bitmap of a virtual map related to a virtual scene, the first fog bitmap comprising color values of a plurality of bitmap regions, the plurality of bitmap regions being in one-to-one correspondence with a plurality of first map regions on the virtual map;
determining, in response to a virtual object moving in the virtual scene, an object position of the virtual object on the virtual map based on a scene position of the virtual object in the virtual scene;
updating the color values of the bitmap regions in the first fog bitmap based on the object position, to obtain a second fog bitmap; and
rendering the virtual map based on the second fog bitmap.

2. The method according to claim 1, wherein the updating the color values of the bitmap regions in the first fog bitmap based on the object position, to obtain a second fog bitmap comprises:
determining, among the plurality of first map regions, a second map region within a preset distance from the object position, the color value of a first bitmap region corresponding to the second map region indicating that virtual fog exists in the second map region; and
updating the color value of the first bitmap region in the first fog bitmap, to obtain the second fog bitmap.

3. The method according to claim 1, wherein the rendering the virtual map based on the second fog bitmap comprises:
rendering, for any bitmap region in the second fog bitmap having a first color value, the virtual fog in a first map region corresponding to the bitmap region; and
rendering, when the bitmap region has a second color value, a virtual map icon in the first map region.

4. The method according to claim 1, wherein the rendering the virtual map based on the second fog bitmap comprises:
interpolating the second fog bitmap based on the color values of the bitmap regions in the second fog bitmap, to obtain a third fog bitmap; and
rendering the virtual map based on the third fog bitmap.

5. The method according to claim 4, wherein the rendering the virtual map based on the third fog bitmap comprises:
adding noise to the third fog bitmap based on a noise map, to obtain a fourth fog bitmap; and
rendering the virtual map based on the fourth fog bitmap.

6. The method according to claim 1, further comprising:
determining a division size of a single first map region based on a resolution of the virtual map and a preset division rule, the preset division rule indicating that a size ratio of the single first map region to the virtual map after division is within a preset range; and
dividing the virtual map into the plurality of first map regions based on the division size.

7. The method according to claim 1, further comprising:
obtaining a scene complexity corresponding to each position on the virtual map, the scene complexity corresponding to the position being configured for indicating a quantity of virtual matters located at the position in the virtual scene; and
dividing the virtual map into the plurality of first map regions based on the scene complexity corresponding to each position on the virtual map, a size of each first map region being in negative correlation with the scene complexity.

8. The method according to claim 1, wherein the virtual map further comprises a plurality of third map regions, and each third map region comprises the plurality of first map regions; and
the method further comprises:
updating, for any third map region, a color value corresponding to the third map region in a fifth fog bitmap when the virtual object completes a virtual task corresponding to the third map region; and
obtaining a contour of the third map region on the virtual map based on the updated fifth fog bitmap.

9. A computer device, comprising a processor and a memory, the memory being configured to store at least one computer program, and the at least one computer program, when loaded and executed by the processor, causing the computer device to perform a virtual map rendering method including:
obtaining a first fog bitmap of a virtual map related to a virtual scene, the first fog bitmap comprising color values of a plurality of bitmap regions, the plurality of bitmap regions being in one-to-one correspondence with a plurality of first map regions on the virtual map;
determining, in response to a virtual object moving in the virtual scene, an object position of the virtual object on the virtual map based on a scene position of the virtual object in the virtual scene;
updating the color values of the bitmap regions in the first fog bitmap based on the object position, to obtain a second fog bitmap; and
rendering the virtual map based on the second fog bitmap.

10. The computer device according to claim 9, wherein the updating the color values of the bitmap regions in the first fog bitmap based on the object position, to obtain a second fog bitmap comprises:
determining, among the plurality of first map regions, a second map region within a preset distance from the object position, the color value of a first bitmap region corresponding to the second map region indicating that virtual fog exists in the second map region; and
updating the color value of the first bitmap region in the first fog bitmap, to obtain the second fog bitmap.

11. The computer device according to claim 9, wherein the rendering the virtual map based on the second fog bitmap comprises:
rendering, for any bitmap region in the second fog bitmap having a first color value, the virtual fog in a first map region corresponding to the bitmap region; and
rendering, when the bitmap region has a second color value, a virtual map icon in the first map region.

12. The computer device according to claim 9, wherein the rendering the virtual map based on the second fog bitmap comprises:
interpolating the second fog bitmap based on the color values of the bitmap regions in the second fog bitmap, to obtain a third fog bitmap; and
rendering the virtual map based on the third fog bitmap.

13. The computer device according to claim 12, wherein the rendering the virtual map based on the third fog bitmap comprises:
adding noise to the third fog bitmap based on a noise map, to obtain a fourth fog bitmap; and
rendering the virtual map based on the fourth fog bitmap.

14. The computer device according to claim 9, wherein the method further comprises:
determining a division size of a single first map region based on a resolution of the virtual map and a preset division rule, the preset division rule indicating that a size ratio of the single first map region to the virtual map after division is within a preset range; and
dividing the virtual map into the plurality of first map regions based on the division size.

15. The computer device according to claim 9, wherein the method further comprises:
obtaining a scene complexity corresponding to each position on the virtual map, the scene complexity corresponding to the position being configured for indicating a quantity of virtual matters located at the position in the virtual scene; and
dividing the virtual map into the plurality of first map regions based on the scene complexity corresponding to each position on the virtual map, a size of each first map region being in negative correlation with the scene complexity.

16. The computer device according to claim 9 wherein the virtual map further comprises a plurality of third map regions, and each third map region comprises the plurality of first map regions; and
the method further comprises:
updating, for any third map region, a color value corresponding to the third map region in a fifth fog bitmap when the virtual object completes a virtual task corresponding to the third map region; and
obtaining a contour of the third map region on the virtual map based on the updated fifth fog bitmap.

17. A non-transitory computer-readable storage medium, configured to store at least one computer program, the at least one computer program, when executed by a processor of a computer device, causing the computer device to perform a virtual map rendering method including:
obtaining a first fog bitmap of a virtual map related to a virtual scene, the first fog bitmap comprising color values of a plurality of bitmap regions, the plurality of bitmap regions being in one-to-one correspondence with a plurality of first map regions on the virtual map;
determining, in response to a virtual object moving in the virtual scene, an object position of the virtual object on the virtual map based on a scene position of the virtual object in the virtual scene;
updating the color values of the bitmap regions in the first fog bitmap based on the object position, to obtain a second fog bitmap; and
rendering the virtual map based on the second fog bitmap.

18. The non-transitory computer-readable storage medium according to claim 17, wherein the updating the color values of the bitmap regions in the first fog bitmap based on the object position, to obtain a second fog bitmap comprises:
determining, among the plurality of first map regions, a second map region within a preset distance from the object position, the color value of a first bitmap region corresponding to the second map region indicating that virtual fog exists in the second map region; and
updating the color value of the first bitmap region in the first fog bitmap, to obtain the second fog bitmap.

19. The non-transitory computer-readable storage medium according to claim 17, wherein the rendering the virtual map based on the second fog bitmap comprises:
rendering, for any bitmap region in the second fog bitmap having a first color value, the virtual fog in a first map region corresponding to the bitmap region; and
rendering, when the bitmap region has a second color value, a virtual map icon in the first map region.

20. The non-transitory computer-readable storage medium according to claim 17, wherein the rendering the virtual map based on the second fog bitmap comprises:
interpolating the second fog bitmap based on the color values of the bitmap regions in the second fog bitmap, to obtain a third fog bitmap; and
rendering the virtual map based on the third fog bitmap.
